(19) United States
(12) Patent Application Publication
(10) Pub. No.: US 2011/0078920 A1
(43) Pub. Date: Apr. 7, 2011

(54) SWEAT-ABSORBING SHOE SOLE INSERTS HAVING IMPROVED SWEAT ABSORPTION

(75) Inventors: Juri Tschernjaew, Aschaffenburg (DE); Maya Krapfl, Frankfurt (DE); Patrick Stenner, Hanau (DE); Michael Beyer, Raesfeld (DE); Harald Haeger, Luedinghausen (DE); Dirk Heinrich, Herten (DE); Martina Gottheis, Langenselbold (DE)

(73) Assignee: EVONIK DEGUSSA GmbH, ESSEN (DE)

(21) Appl. No.: 12/996,539

(22) PCT Filed: Jun. 17, 2009
(86) PCT No.: PCT/EP09/57516

§ 371 Date: Dec. 6, 2010

(30) Foreign Application Priority Data
Jul. 9, 2008 (DE) 10 2008 040 264.8

(51) Int. Cl. A43B 13/38; A01N 25/12; C08L 27/06; C01B 33/12

(52) U.S. Cl. 36/44; 514/770; 524/567; 423/335

(57) ABSTRACT

A method of improving perspiration absorbency in a shoe or boot using particulate amorphous silica as an absorbent in insoles for shoes and/or boots, as well as a shoe insole containing an absorbent which contains particulate amorphous silica, and footware containing the insole.

The present invention relates to perspiration-absorbing shoe insoles with improved absorption of perspiration. It relates especially to the use of particulate amorphous silica as an absorbent for absorption of perspiration in shoe insoles.

It is known that humans excrete about 100 l of perspiration per year through the feet, i.e. about 137 ml per day and per foot. Considering that a human in everyday work or even in leisure time, for example when skiing, wears the same footwear for up to 10 hours uninterrupted, about 60 ml of perspiration is released to the footwear per foot within this time. For humans, however, it is not just uncomfortable to have a constant feeling of damp feet. The damp and warm climate in the footwear additionally also promotes the growth of bacteria, and the release of unpleasant odours.

There has therefore been no lack of attempts in the past to find ways of remedying the outlined problems of sweaty feet. Almost all approaches to a solution make use of an insole which is intended to preferentially absorb and store the perspiration absorbed. For this purpose, multilayer systems are often used, in which case an upper layer in contact with the foot is intended to ensure the transport of the perspiration into the interior of the sole, a middle layer is intended to store the perspiration, and a lower layer in contact with the shoe sole should retain the absorbed perspiration. In order to be able to deal with the large amounts of perspiration excreted, the material for the middle layer of a shoe insole is generally selected according to its ability to absorb and store aqueous liquids. Activated carbon, as an inexpensive absorbent, however, has only a comparatively low storage capacity. A comparatively high storage capacity, in contrast, is possessed by so-called “superabsorbent” polymers which are capable of absorbing and of storing several times their own weight or volume of liquid. Superabsorbent salts are used, for example, in DE 691 08 004 T2 as a preferred absorbent in the cavities of the middle layer of a shoe insole, one membrane allowing the transfer of the moisture from one cavity to another. However, a disadvantage is the significant swelling of the polymer particles, which can also lead to further liquid absorption being prevented through so-called “gel blocking”.

DE 35 16 653 A1 describes footwear in which shoe mouldings forming the shoe interior boundary are preferably equipped with a molecular sieve. Although molecular sieves do not tend to swell on absorption of moisture, the very uniform pore and channel structure causes molecular sieves to release the liquid again, once it has been absorbed, only under harsh conditions.

The prior art shoe insoles thus have the disadvantage that they either possess an only insufficient perspiration absorption capacity or tend to significant swelling at the direct site of absorption of perspiration. In no case to date, however, have they been able to ensure that the perspiration can be led away from the direct site of absorption of perspiration and distributed homogeneously over the surface of the shoe insoles. Moreover, the prior art shoe insoles have the disadvantage that, in an attempt to regenerate the insoles for further applications, the perspiration absorbed is desorbed again only to an insufficient degree, i.e. long drying times and/or high drying temperatures are required across the board.

It was therefore an object of the present invention to provide a shoe insole which possesses a sufficient perspiration absorption capacity, but does not swell as a result of absorbing perspiration, and additionally ensures that the perspiration absorbed can be distributed effectively over the entire shoe sole volume and can be released again to the environment just as effectively in the course of regeneration.

It has now been found that, surprisingly, a shoe insole which contains particulate amorphous silica meets the aforementioned requirements.

The present invention therefore provides for the use of particulate amorphous silica as an absorbent in insoles for shoes and/or boots.

“Particulate” or “particle” in the context of the present invention denotes a three-dimensional body with a defined outer shape which—according to the size of the particle—can be detected by means of microscopic methods (light microscope, electron microscope, etc.). The inventive particles may be porous, i.e. have pores and/or inner cavities.

In the context of the present invention, it is possible to use all commercial particulate amorphous silicas. The amorphous silica is preferably completely amorphous. In the context of the invention, it may, however, also possess a smaller crystalline component which is, for example, not more than 40%, not more than 35%, not more than 30%, not more than 25%, not more than 20%, not more than 15%, not more than 10% or not more than 5%. The crystalline component is determined in a known manner by means of X-ray diffraction. Suitable amorphous silicas are, for example, precipitated silicas and fumed silicas. Preference is given in accordance with the invention to the commercially available silicas from Evonik Degussa GmbH which are obtainable, for example, under the tradenames Sipernat 2200, Sipernat 22 or Sipernat 50.

It has been found to be advantageous that the silica used in accordance with the invention has a specific surface area (N₂) to ISO 5794-1 Annex D in the range from 5 to 500 m² per g. The silica more preferably has a specific surface area in the range from 50 to 500 m², even more preferably in the range from 150 to 500 m² and especially preferably in the range from 185 to 475 m² per g.

It has additionally been found to be advantageous that the silica used in accordance with the invention has a DBP absorption (to DIN 53601) of at least 180 g per 100 g. The DBP absorption of the silica is preferably in the range from 180 to 600 per 100 g, more preferably from 200 to 600 per 100 g, even more preferably from 200 to 500 per 100 g and especially preferably from 250 to 400 per 100 g.

Especially suitable are silicas whose product of DBP absorption (to DIN 53601) and tamped density to ISO 787/11 is at least 30 000 g/100 g*g/l, preferably at least 40 000 g/100 g*g/l, more preferably at least 50 000 g/100 g*g/l and most preferably at least 65 000 g/100 g*g/l.

It has additionally been found to be advantageous that the mean particle size d₅₀ of the silica is in the range from 5 μm to 500 μm, preferably from 20 μm to 450 μm, more preferably from 30 to 400 μm, and most preferably from 45 to 350 μm. When the particles are too small, the result may be undesired dust formation. Excessively large particles in turn have the disadvantage that they are often mechanically unstable and possess excessively deep pores, such that the absorption and desorption rates can become too low or parts of the absorbed perspiration can no longer be desorbed.

The present invention further provides a shoe insole containing an absorbent which contains a particulate silica for use in accordance with the invention.

The inventive shoe insoles may contain active antibacterial ingredients. In the present invention, active antibacterial ingredients are understood to mean chemical compounds or natural products which are capable of preventing growth of microorganisms, for example bacteria, yeasts or moulds. The active antimicrobial ingredients used may be known preservatives, for example organic acids (sorbic acid, propionic acid, acetic acid, lactic acid, citric acid, malic acid, benzoic acid) and salts thereof, PHB esters and salts thereof, sodium sulphite and corresponding salts, nisin, natamycin, formic acid, hexamethylenetetramine, sodium tetraborate, lysozyme, alcohols, organohalogen compounds, parabens (methyl-, ethyl-, propyl-, butyl-, isobutyl-, propylparaben), isothiazolones (benzisothiazolone, methylisothiazolone, octylisothiazolone), phenols, salicylates, nitriles, fragrances, aromas, and other vegetable or synthetic active ingredients with antimicrobial efficacy.

The inventive shoe insoles may contain fragrances, aromas or odourants, which are referred to hereinafter collectively as fragrances. Such substances are common knowledge and commercially available. As used herein, they comprise natural (i.e. substances obtained, for example, by extraction of plants, for example flowers, herbs, leaves, roots, bark, wood, blossom, etc., or animal products), artificial (i.e. a mixture of different natural oils or oil constituents) and synthetic (i.e. synthetically produced), fragrant substances or mixtures of these substances. Such materials are frequently used together with further compounds, such as fixatives, extenders, stabilizers and solvents. These assistants or additives are encompassed in the context of the present invention by the meaning of the term “fragrance”.

Usually, fragrances are therefore complex mixtures of a multitude of organic compounds. The natural compounds include not only volatile substances; they also include substances of medium volatility and moderate volatility. An illustrative list of fragrances comprises the following compounds among others:

Natural products such as tree moss absolute, basil oil, citrus fruit oils (such as bergamot oil, mandarin oil, etc.), mastic absolute, myrtle oil, palmarosa oil, oils from the patchouli plant, petitgrain oil, especially from Paraguay, wormwood oil; alcohols such as farnesol, geraniol, linalool, nerol, phenylethyl alcohol, rhodinol, cinnamyl alcohol; aldehydes such as citral, helional, α-hexylcinnamaldehyde, hydroxycitronellal, lilial (p-tert-butyl-α-methyldihydrocinnamaldehyde), methylnonylacetaldehyde; ketones such as allylionone (1-(2,6,6-trimethyl-2-cyclohexen-1-yl)-1,6-heptadien-3-one), α-ionone, β-ionone, isomethyl-α-ionone, methylionone; esters such as allyl phenoxyacetate, benzyl salicylate, cinnamyl propionate, citronellyl acetate, citronellyl ethoxylate, decyl acetate, dimethylbenzylcarbinyl acetate, dimethylbenzylcarbinyl butyrate, ethyl acetoacetate, ethyl acetylacetate, hexenyl isobutyrate, linalyl acetate, methyl dihydrojasmonate, styrallyl acetate, vetiveryl acetate, etc.; lactones such as γ-undecalactone; various constituents which are frequently used for producing perfumes, such as musk ketone, indole, p-menthane-8-thiol-3-one and methyl eugenol; and acetals and ketals such as methyl and ethyl acetals and ketals, and the acetals or ketals which are based on benzaldehyde and contain phenylethyl groups, or acetals and ketals of the oxotetralins and oxoindanes.

Additionally useful are: geranyl acetate, dihydromyrcenyl acetate (2,6-dimethyl-oct-7-en-2-yl acetate), terpinyl acetate, tricyclodecenyl acetate, tricyclodecenyl propionate, 2-phenylethyl acetate, benzyl acetate, benzyl benzoate, styrallyl acetate, amyl salicylate, phenoxyethyl isobutyrate, neryl acetate, trichloromethylphenylcarbinyl acetate, p-tert.-butylcyclohexyl acetate, isononyl acetate, cedryl acetate, benzyl alcohol, tetrahydrolinalool, citronellol, dimethylbenzylcarbinol, dihydromyrcenol, tetrahydromyrcenol, terpineol, eugenol, vetiverol, 3-isocamphylcyclohexanol, 2-methyl-3-(p-tert-butylphenyl)propanol, 2-methyl-3-(p-isopropylphenyl)propanol, 3-(p-tert-butylphenyl)propanol, α-n-amylcinnamaldehyde, 4-(4-hydroxy-4-methylpentyl)-3-cyclohexenecarbaldehyde, 4-(4-methyl-3-pentenyl)-3-cyclohexenecarbaldehyde, 4-acetoxy-3-pentyltetrahydropyran, 2-n-heptylcyclopentanone, 3-methyl-2-pentyl-cyclopentanone, n-decanal, n-dodecanal, hydroxycitronellal, phenylacetaldehyde dimethyl acetal, phenylacetaldehyde diethyl acetal, geranonitrile, citronellonitrile, cedryl methyl ether, isolongifolanone, aubepine nitrile, aubepine, heliotropin, coumarin, vanillin, diphenyl oxide, ionone, methylionone, isomethylionone, cis-3-hexenol and cis-3-hexenol esters, musk compounds which may have, among other structure components, an indane, tetralin or isochromane structure, macrocyclic ketones, macrolactone musk compounds, ethylene brassylate, aromatic nitro musk compounds, wintergreen oil, oregano oil, bayleaf oil, peppermint oil, mint oil, clove oil, sage oil, sassafras oil, lemon oil, orange oil, anise oil, benzaldehyde, bitter almond oil, camphor, cedar leaf oil, marjoram oil, lemongrass oil, lavender oil, mustard oil, pine oil, pineneedle oil, rosemary oil, thyme oil, cinnamon leaf oil and mixtures of these substances. The fragrances mentioned can be used individually or as a mixture.

It has been found to be advantageous that the proportion of the active antibacterial ingredients and/or of the fragrances is in the range from 0.01 to 10% by weight based on the total weight of all particles. The ideal ratio depends on the chemical nature and the physicochemical properties of the active antibacterial ingredients and of the fragrances, and also of the silica, and can be determined for each material combination by simple test series. A higher loading of the silica can lead to the effect that perspiration can no longer be incorporated sufficiently into the pores. The proportion of the active antibacterial ingredients and/or of the fragrances based on the total weight of all particles is more preferably in the range from 0.01 to 5% by weight, even more preferably in the range from 0.05 to 3% by weight and especially preferably in the range from 0.5 to 3% by weight.

It has also been found to be advantageous that at least a portion of the inventive silica is present as a carrier for the active antibacterial ingredients and/or the fragrances. The proportion of the silica particles which are present as a carrier for the active antibacterial ingredients and/or the fragrances is preferably in the range from 5 to 40% by weight based on the total weight of all particles, more preferably in the range from 5 to 30% by weight, most preferably in the range from 5 to 20% by weight.

The inventive shoe insoles may additionally also contain particulate superabsorbent polymers. In the context of the present invention, superabsorbent polymers (SAPs) are understood to mean polymers which are capable of absorbing several times their own weight—up to 1000 times—of liquids (usually water or aqueous solutions). The product is used as a white, coarse particulate powder with particle sizes of 100-1000 μμm (=0.1-1.0 mm).

Suitable superabsorbent polymers are especially polymers of (co)polymerized hydrophilic monomers, (graft co)polymers of one or more hydrophilic monomers onto a suitable graft base, for instance crosslinked cellulose or starch ethers, crosslinked carboxymethylcellulose, partly crosslinked polyalkylene oxide, or natural products which are swellable in aqueous liquids, for example guar derivatives, alginates and carrageenans. Preference is given to polymers which are obtained by crosslinked polymerization or copolymerization of monoethylenically unsaturated monomers bearing acid groups or derivatives thereof, especially salts, esters or anhydrides. Such monomers bearing acid groups are, for example, monoethylenically unsaturated C₃-C₂₅-carboxylic acid, or salts or anhydrides thereof. Monomers used with preference are acrylic acid, methacrylic acid, vinylsulphonic acid, acrylamidopropanesulphonic acid, or mixtures of these acids. Particular preference is given to acrylic acid and methacrylic acid. To optimize properties, it is possible to use additional monoethylenically unsaturated compounds which do not bear an acid group but are polymerizable with the monomers bearing acid groups. These include, for example, the amides and nitriles of monoethylenically unsaturated carboxylic acids.

The crosslinkers used may be compounds which have at least two ethylenically unsaturated double bonds. Examples of compounds of this type are N,N-methylenebisacrylamide, polyethylene glycol diacrylates and polyethylene glycol dimethacrylates.

Suitable superabsorbent polymers are described, for example, in the following reference: F. L. Buchholz, A. T. Graham (Ed.), Modern Superabsorbent Polymer Technology, Wiley-VCH, New York 1998.

In addition, the superabsorbent polymers can be used in combination with copolymers of C₂- to C₈-olefins or styrenes with anhydrides, in order to improve the odour-binding properties.

It has been found to be advantageous that the particles of the superabsorbent polymers have a mean particle size d₅₀ in the range from 5 μm to 300 μm, preferably from 20 μm to 150 μm, more preferably from 50 to 150 μm and most preferably from 50 to 100 μm.

The proportion of all particles is preferably at least 20% by volume based on the total volume of the inventive shoe insole, more preferably at least 30% by volume and most preferably at least 35% by volume.

In a preferred embodiment, the inventive shoe insole comprises at least two layers, of which one layer is water- and water vapour-pervious and the other layer is water- and water vapour-impervious, the water- and water vapour-impervious layer contains depressions on its side facing the water- and water vapour-pervious layer, both layers are fixed to one another in such a way that the water- and water vapour-pervious layer covers the depressions on the side of the water- and water vapour-impervious layer facing toward it, the depressions of the water vapour-impervious layer are joined to one another by open channels within this layer, and the depressions of the water- and water vapour-impervious layer contain a particulate amorphous silica for use in accordance with the invention. This embodiment is advantageous because the sole structure optimally promotes transport of perspiration within the absorbent and exchange of perspiration (absorption and release) with the environment.

The present invention further provides for the use of the inventive shoe insole in sports, work or military shoes or boots.

### FIGURES

FIG. 1: schematic diagram of an inventive shoe insole

FIG. 1 shows an inventive shoe insole in cross section, which comprises at least two layers 1 and 2, layer 1 being water- and water vapour-pervious and layer 2 being water- and water vapour-impervious. Layer 2 contains depressions on surface 3. Layers 1 and 2 are fixed to one another in such a way that surface 4 of layer 1 covers the depressions on surface 3 of layer 2. The depressions on surface 3 of layer 2 are joined to one another by open channels within layer 2. The depressions on surface 3 of layer 2 contain the absorbent 5 for use in accordance with the invention.

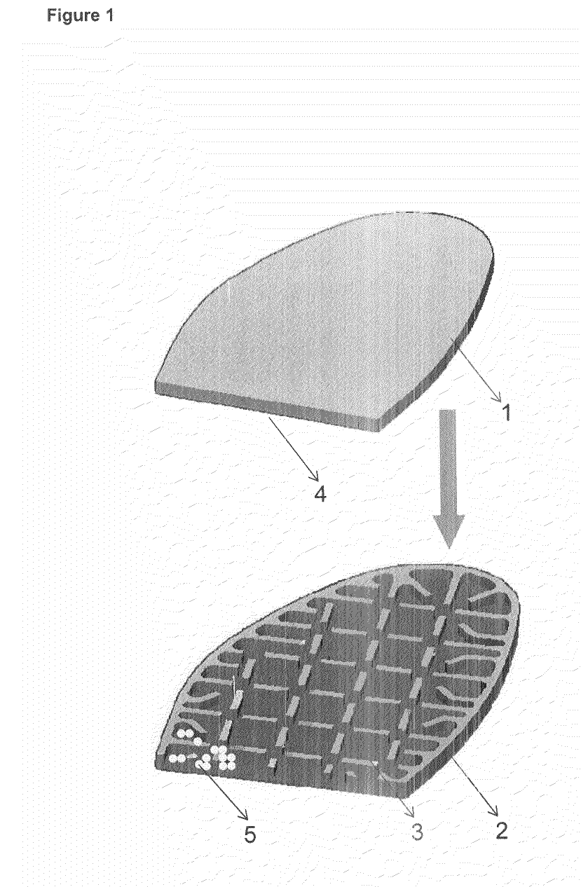

The present invention is illustrated in detail hereinafter with reference to examples.

Test Methods

Determination of the DBP Number:

The DBP absorption (DBP number), which is a measure of the absorbancy of a porous material, is determined according to standard DIN 53601 as follows: 12.5 g of the pulverulent or pelletized material with moisture content 0-10% (if appropriate, the moisture content is adjusted by drying at 105° C. in a drying cabinet) are introduced into the kneader chamber (article number 279061) of the Brabender “E” absorptometer (without damping the output filter of the torque sensor). In the case of granules, the sieve fraction from 3.15 to 1 mm (stainless steel sieves from Retsch) is used (by soft pressing of the granules with a plastic spatula through the sieve of pore size 3.15 mm). With constant mixing (peripheral speed of the kneader blades 125 rpm), DBP is added dropwise to the mixture at 25° C. by means of the “Brabender T 90/50 Dosimat” at a rate of 4 ml/min. The mixing requires only a low force and is monitored with the digital display. Toward the end of the determination, the mixture becomes pasty, which is indicated by means of a steep rise in the force required. When the display shows 600 digits (torque of 0.6 Nm), an electrical contact switches off both the kneader and the metered addition of DBP. The synchronous motor for the DBP feed is coupled to a digital counter, such that the consumption of DBP in ml can be read off. The DBP absorption is reported in the unit [g/100g] with no decimal places and is calculated using the following formula:

DBP=(V*D*100)/E*(g/100 g)+K

where
DBP=DBP absorption in g/100 g
V=consumption of DBP in ml
D=density of DBP in g/ml (1.047 g/ml at 20° C.)
E=starting weight of silica in g
K=correction value according to moisture correction table in g/100 g

DBP absorption is defined for anhydrous dried materials. When moist materials are used, especially precipitated silica or silica gels, the correction value K has to be included for the calculation of the DBP absorption. This value can be determined using the following correction table. For example, a water content of the material of 5.8% would mean an addition of 33 g/100 g for the DBP absorption. The moisture content of the material is determined by the “Determination of the moisture content or of the drying loss” method described below.

TABLE 1
Moisture correction table for dibutyl phthalate absorption,
anhydrous

| % moisture | .0 | .2 | .4 | .6 | .8 |
|---|---|---|---|---|---|
| 0 | 0 | 2 | 4 | 5 | 7 |
| 1 | 9 | 10 | 12 | 13 | 15 |
| 2 | 16 | 18 | 19 | 20 | 22 |
| 3 | 23 | 24 | 26 | 27 | 28 |
| 4 | 28 | 29 | 29 | 30 | 31 |
| 5 | 31 | 32 | 32 | 33 | 33 |
| 6 | 34 | 34 | 35 | 35 | 36 |
| 7 | 36 | 37 | 38 | 38 | 39 |
| 8 | 39 | 40 | 40 | 41 | 41 |
| 9 | 42 | 43 | 43 | 44 | 44 |
| 10 | 45 | 45 | 46 | 46 | 47 |

Determination of the Moisture Content or of the Drying Loss

The moisture content or else the drying loss (TV) of materials is determined on the basis of ISO 787-2 at 105° C. after drying for 2 hours. This drying loss consists predominantly of water moisture.

Procedure

10 g of the pulverulent, pelletized or granular material are weighed accurately to 0.1 mg (starting weight E) into a dry weighing bottle with a flanged lid (diameter 8 cm, height 3 cm). With the lid open, the sample is dried in a drying cabinet at 105±2° C. for 2 h. Subsequently, the weighing bottle is closed and cooled to 25° C. in a desiccator cabinet with silica gel as the desiccant. To determine the final weight A, the weighing bottle is weighed accurately to 0.1 mg on a precision balance. The moisture content (TV) in % is determined by

TV=(1−A/E)*100

where A=final weight in g and E=starting weight in g.

Mean Particle Size d₅₀

The mean particle size d₅₀ of the silica is determined by the principle of laser diffraction on a laser diffractometer (from Horiba, LA-920). To determine the particle size of powders, a dispersion with a proportion by weight of approx. 1% by weight of SiO₂ is prepared by stirring the powder into water. Immediately after the dispersion, the particle size distribution of a sample of the dispersion is determined with the laser diffractometer (Horiba LA-920). For the measurement, a relative refractive index of 1.09 should be selected. All measurements are made at 25° C. The particle size distribution and the relevant parameters, for example the mean particle size d₅₀, are calculated automatically and shown in graphic form by the instrument. The instructions in the operating manual should be noted.

Tamped Density

The tamped density or else apparent density is determined to ISO 787-11.

SiO₂ Content

The SiO₂ content is determined to ISO 3262-19.

TABLE 2
Physicochemical characteristics of various silicas

| | Silica No.* | | | | | | | | | | |
|---|---|---|---|---|---|---|---|---|---|---|---|
| Feature | Unit | 1 | 2 | 3 | 4 | 5 | 6 | 7 | 8 | 9 | 10 |
| Specific surface area | m²/g | 190 | 175 | 190 | 185 | 450 | 450 | 450 | 175 | 50 | 50 |
| Mean particle size d₅₀ | μm | 110 | 8 | 11.5 | 320 | 40 | 16 | 6 | 20 | 4.5 | 18 |
| Tamped density | g/l | 280 | 70 | 90 | 260 | 180 | 90 | 75 | 175 | 110 | 210 |
| Drying loss | % | 6 | 6 | 6 | 5 | 6 | 6 | 3 | 6 | 5 | 6 |
| pH | | 6.5 | 6.2 | 6.5 | 6 | 6 | 6 | 6 | 6.3 | 9 | 9 |
| DBP absorption | g/100 g | 260 | 265 | 265 | 250 | 335 | 325 | 325 | 225 | 210 | 245 |
| SiO₂ content | % | 98 | 98 | 98 | 98 | 98.5 | 98.5 | 98.5 | 98 | 98.5 | 98 |
| Tamped density* DBP Abs. | g/100 g * g/l | 72800 | 18550 | 23850 | 65000 | 60300 | 29250 | 24375 | 39375 | 23100 | 51450 |

*Silica No. 1: “Sipernat 22” from Evonik Degussa GmbH
Silica No. 2: “Sipernat 22 LS” from Evonik Degussa GmbH
Silica No. 3: “Sipernat 22 S” from Evonik Degussa GmbH
Silica No. 4: “Sipernat 2200” from Evonik Degussa GmbH
Silica No. 5: “Sipernat 50” from Evonik Degussa GmbH
Silica No. 6: “Sipernat 50 S” from Evonik Degussa GmbH
Silica No. 7: “Sipernat 500 LS” from Evonik Degussa GmbH
Silica No. 8: “Sipernat 320” from Evonik Degussa GmbH
Silica No. 9: “Sipernat 350” from Evonik Degussa GmbH
Silica No. 10: “Sipernat 360” from Evonik Degussa GmbH

Test Series

For the performance of the tests, a sole composed of a water- and water vapour-impervious PVC layer (layer 2), i.e. without a water- and water vapour-pervious layer (layer 1), in European shoe size 46 (length approx. 30 cm) was used. Two test series were carried out, one using silica No. 4 (Example 1) as the absorbent, the other silica No. 4 and silica No. 5 in a ratio of 95 to 5% by weight (Example 2). For comparison, on the basis of DE 3516653 A1, a shoe insole was filled with molecular sieve (Example 3; not inventive). This was a molecular sieve from Merck KGaA with a pore diameter of 0.5 nm and a mean particle size of approx. 2 mm (sodium aluminium silicate, catalogue number 195705). The absorbent was always introduced in the same amount (15 g) into the depressions of the PVC layer. In order to simulate human perspiration, a sodium chloride solution consisting of 99% by weight of water and 1% by weight of sodium chloride (NaCl) was prepared. 60 ml of this solution was added to the absorbent in each case. In the tests, the solution was added to the absorbent at constant rate (0.2 ml/min). The solution was added dropwise at one point, specifically in the toe region, and the spread over time was determined. The laden shoe soles were additionally assessed visually. This involved rating how well the solution had been absorbed by the particular absorbent. The ratings were done with a scale of marks from 1 to 6, the mark 1 meaning complete absorption, and the mark 6 meaning no absorption whatsoever. Table 3 summarizes the results.

TABLE 3
Spread kinetics and visual assessment

| | Example No. | | |
|---|---|---|---|
| | 1 | 2 | 3 |
| Time/min | Spread/cm | | |
| 0 | 0.0 | 0.0 | 0.0 |
| 10 | 2.0 | 2.0 | 2.5 |
| 20 | 2.8 | 3.0 | 3.2 |
| 30 | 3.8 | 3.7 | 4.0 |
| 60 | 6.6 | 5.2 | 6.2 |
| 90 | 8.6 | 7.0 | 8.2 |
| 120 | 10.2 | 9.5 | 11.2 |
| 150 | 12.3 | 11.5 | 13.7 |
| 180 | 16.0 | 14.2 | 18.0 |
| 210 | 21.0 | 18.0 | 21.6 |
| 240 | 23.0 | 22.0 | 25.0 |
| 270 | 25.5 | 26.0 | 25.6 |
| 300 | 25.5 | 26.0 | 25.6 |
| visual | 2 | 1 | 5 |
| assessment | | | |

The spread rates when molecular sieve (Example 3) and amorphous particulate silicas (Examples 1 and 2) are used are comparable at first. While, however, the liquid was absorbed virtually completely by the absorbent when amorphous particulate silicas were used, in contrast, the liquid was present for the most part as “free” liquid between the particles when molecular sieve was used. This finding shows clearly that both the absorption capacities (determined by pore volume) and the actual absorption rates (determined by wetting properties and pore sizes) in the case of amorphous particulate silicas are much more advantageous compared to molecular sieves.

In addition, it was checked whether the soles laden in the manner described above can be regenerated or dried overnight. For this purpose, the soles were placed into a drying cabinet with a temperature of 50° C. overnight (this corresponds roughly to the conditions of drying on a radiator), and the decrease in weight was measured.

In the case of the sole laden with molecular sieve (Example 3), in spite of solution present in “free” form, a significant residual moisture content of 17% by weight was still found after 12 h. The residual moisture content was determined gravimetrically.

The soles laden with amorphous particulate silicas as the absorbent (Examples 1 and 2) were completely dry as early as after five hours under the same conditions (T=50° C.).

The results confirm the advantages in the case of use of amorphous particulate silica as an absorbent in hygienic insoles both in relation to the absorption of perspiration (redistribution in the case of asymmetric evolution of perspiration) and in relation to drying (regeneratability).

1. A method of improving perspiration absorbency in a shoe insole or boot insole, the method comprising adding particulate amorphous silica to the shoe insole or boot insole.

2. The method of claim 1, wherein the particulate amorphous silica has a specific surface area in a range from 5 to 500 m² per g to ISO 5794-1 Annex D.

3. The method of claim 1, wherein the particulate amorphous silica has a DBP absorption to DIN 53601 of at least 180 g per 100 g.

4. The method of claim 1, wherein the particulate amorphous silica has a mean particle size (d₅₀) in a range from 5 to 500 μm.

5. The method of claim 1, wherein a product of DBP absorption to DIN 53601 and tamped density to ISO 787/11 for the particulate amorphous silica is at least 30 000 g/100 g*g/l.

6. A shoe insole, comprising an absorbent, wherein the absorbent comprises particulate amorphous silica.

7. The shoe insole of claim 6, wherein the absorbent additionally comprises at least one active antibacterial ingredient and/or fragrance.

8. The shoe insole of claim 6, wherein a proportion of the at least one active antibacterial ingredient and/or fragrance is in a range from 0.01 to 10% by weight based on a total weight of all particles.

9. The shoe insole of claim 7, wherein at least a portion of the particulate amorphous silica is present as a carrier for the at least one active antibacterial ingredient and/or fragrance.

10. The shoe insole of claim 9, wherein a proportion of the silica particles which are present as the carrier is in a range from 5 to 40% by weight based on a total weight of all particles.

11. The shoe insole of claim 6, wherein the absorbent additionally comprises at least one particulate superabsorbent polymer.

12. The shoe insole of claim 11, wherein the at least one particulate superabsorbent polymer has a mean particle size (d₅₀) in a range from 5 to 300 μm.

13. The shoe insole of claim 6, wherein a proportion of all particles is at least 20% by volume based on a total volume of the insole.

14. The shoe insole of claim 6, wherein:
the shoe insole comprises at least a first layer and a second layer;
the first layer is water-pervious and water vapor-pervious;
the second layer is water-impervious and water vapor-impervious;
the second layer comprises depressions on a top surface of the second layer;
the first and second layers are fixed to one another in such a way that a bottom surface of the first layer covers the depressions on the top surface of the second layer;
the depressions on the top surface of the second layer are joined to one another by open channels within the second layer; and
the depressions on the top surface of the second layer comprise the particulate amorphous silica of claim 1.

15. A shoe or boot comprising the shoe insole of claim 6.

16. The method of claim 2, wherein the particulate amorphous silica has a DBP absorption to DIN 53601 of at least 180 g per 100 g.

17. The method of claim 2, wherein the particulate amorphous silica has a mean particle size (d₅₀) in a range from 5 to 500 μm.

18. The method of claim 3, wherein the particulate amorphous silica has a mean particle size (d₅₀) in a range from 5 to 500 μm.

19. The method of claim 16, wherein the particulate amorphous silica has a mean particle size (d₅₀) in a range from 5 to 500 μm.

20. The method of claim 2, wherein a product of DBP absorption to DIN 53601 and tamped density to ISO 787/11 for the particulate amorphous silica is at least 30 000 g/100 g*g/l.
